(19) United States
(12) Patent Application Publication
(10) Pub. No.: US 2017/0228695 A1
(43) Pub. Date: Aug. 10, 2017

(54) MARGINAL VALUE BASED CONTENT ITEM MIXING

(71) Applicant: LinkedIn Corporation, Mountain View, CA (US)

(72) Inventors: Ankur Neil Agrawal, San Francisco, CA (US); Krishnaram Kenthapadi, Sunnyvale, CA (US); David Hardtke, Oakland, CA (US)

(21) Appl. No.: 15/040,944

(22) Filed: Feb. 10, 2016

(51) Int. Cl. G06Q 10/10

(52) U.S. Cl. CPC G06Q 10/1053

(57) ABSTRACT

A system and method for marginal value-based content item mixing are provided. In example embodiments, a request to fill a position within a content list is received. A variable monetary value for positioning a particular job listing within the content list is calculated based on an average monetary value and an incremental value for the particular job listing. A first expected value for the particular job listing is computed based on the variable monetary value and an interaction likelihood for the particular job listing. The first expected value is compared with a second expected value corresponding to filling the position within the content list with another content item. The particular job listing within the content list is presented on a user interface of a user device based on the first expected value exceeding the second expected value.

### TECHNICAL FIELD

Embodiments of the present disclosure relate generally to content items presentation and, more particularly, but not by way of limitation, to marginal value based content item mixing.

### BACKGROUND

Feeds, streams, content aggregators, and the like are populated with content items that can both engage users and provide monetization. For instance, a particular feed may include ‘organic’ content items (e.g., news updates, social media updates, user generated content, and so on) as well as monetized content items such as advertisements. In some instances, the monetized content items can be based on different monetization models. For instance, a particular monetized content item may be an advertisement that is pay-per-click or pay-per-impression while another monetized content item may use a flat fee scheme that is results-based or time period-based rather than specifying a number of impressions or clicks. However, determining number of impressions, placement, and other display parameters to maximize revenue in a feed that mixes content items associated with different monetization models presents a number of challenges.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a client-server system within which various example embodiments may be deployed.

FIG. 2 is a block diagram illustrating an example embodiment of a content optimization system, according to some example embodiments.

FIG. 3 is a flow diagram illustrating an example method for evaluating content items in response to a request to fill a position in a content list, according to some example embodiments.

FIG. 4 is a flow diagram illustrating further example operations of the example method for evaluating content items in response to a request to fill a position in a content list, according to some example embodiments.

FIG. 5 is a flow diagram illustrating further example operations of the example method for evaluating content items in response to a request to fill a position in a content list, according to some example embodiments.

FIG. 6 is a flow diagram illustrating further example operations of the example method for evaluating content items in response to a request to fill a position in a content list, according to some example embodiments.

FIG. 7 is a user interface diagram depicting an example user interface that includes a content feed with a mix of content items, according to some example embodiments.

FIG. 8 is a block diagram illustrating an example of a software architecture that may be installed on a machine, according to some example embodiments.

FIG. 9 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

A number of different monetization models can be used to monetize content. For instance, advertisements are typically directly monetized based on a pay-per-click or pay-per-impression model. Some content can be indirectly monetized using a flat fee scheme that is results-based or time period-based rather than specifying a number of impressions or clicks. For example, an employer with a job opening may pay a flat rate fee for creating awareness of the job opening during a specified time period, such as one month. This type of monetization is not based on a number of impressions or a number of clicks and can be more sensible in situations where there a specific result is desired (e.g., filling a single employment position) as opposed to promoting for sale an inexhaustible or nearly inexhaustible product (e.g., a digital good). Content providers and content hosts can monetize their platform by presenting monetized content items in addition to organic content items (e.g., likes, posts, comments, new connections, suggested connections, news articles, or other content of interest to the user). However, space on a user interface to present content is a valuable and limited resource. To optimize revenue from the available space, it is desirable to present the most lucrative monetized content. However, comparing directly monetized content items (e.g., an advertisement) with indirectly monetized content items (e.g., a flat fee scheme) can be a challenge since they cannot be directly compared.

To predict a higher revenue generating content item among directly monetized and indirectly monetized content items, in various example embodiments a server system receives a request to fill a user interface position within a content list. For example, a user of a user device may be viewing a content feed and the content feed may request content items from the server system. The server system calculates a variable monetary value for positioning a particular job listing within the content list. In a various embodiments, the variable monetary value represents a monetary value for filling the position with the particular job listing and can take into account an incremental value and an average monetary value.

In these embodiments, the incremental value represents a diminishing return for subsequent presentations of the job listing. For instance, if the job listing has been presented one thousand times, there may be a reduced value, as compared to an earlier presentation of the job listing, to presenting the job listing again since there is a chance that the position has been filled and showing the job listing would be moot.

In these embodiments, the average monetary value represents a value of filling the available content position with the job listing without regard to a diminishing return. For example, if a flat fee has been paid for presenting the job listing for one month, and, based on historical data, presenting the job listing results in a certain number of user engagements with the job listing (e.g., clicking on the job listing, saving the job listing, and so), then the average monetary value for presenting the job listing may be the flat fee divided by the certain number of user engagements resulting from presenting the job listing. In some embodiments, the server system calculates the average monetary value across multiple jobs (e.g., across a job sector such as technology jobs or a particular type of job such as accountant).

Subsequent to calculating the variable monetary value, the server system may then compute a first expected value for the particular job listing. In various example embodiments, the first expected value is based on the variable monetary value and an interaction likelihood. The interaction likelihood may be a probability that a particular user will interact with the job listing (e.g., based on contextual information such as user data indicating suitability to apply to the job of the particular job listing). The server system may then compare the first expected value with a second expected value corresponding to another content item. For example, the second expected value corresponds to an advertisement. In this example, the second expected value may be a cost-per-click of the advertisement (direct monetization) multiplied by an interaction likelihood with the advertisement (e.g., probability a user will click on the advertisement). In this way, the server system can compare the indirect monetization content (e.g., a flat fee scheme) with the direct monetization content (e.g., an advertisement) on a like-for-like basis. Based on the first expected value exceeding the second expected value, in an embodiment, the server system fills the available content position with the particular job listing instead of the other content item. In this way, the server system can facilitate maximizing revenue derived from available content positions within a content feed or another content platform.

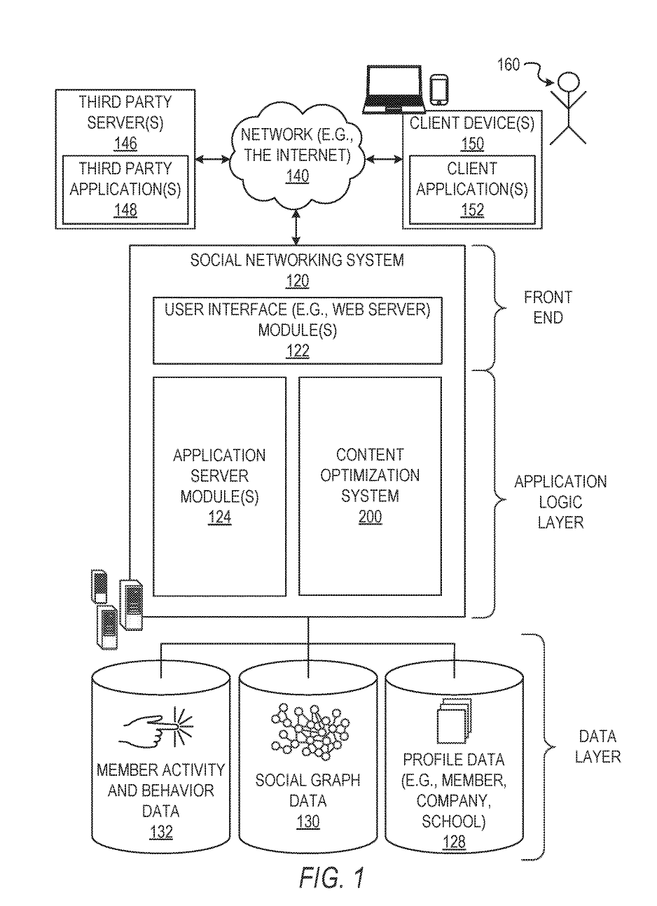

As shown in FIG. 1, a social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such an architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, Application Programming Interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone). For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of the social graph, including member profiles, company profiles, educational institution profiles, as well as information concerning various online or offline groups. Of course, with various alternative embodiments, any number of other entities might be included in the social graph, and as such, various other databases may be used to store data corresponding with other entities.

Consistent with some embodiments, when a person initially registers to become a member of the social networking service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases.

As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130.

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include a content optimization system 200, which is described in more detail below.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

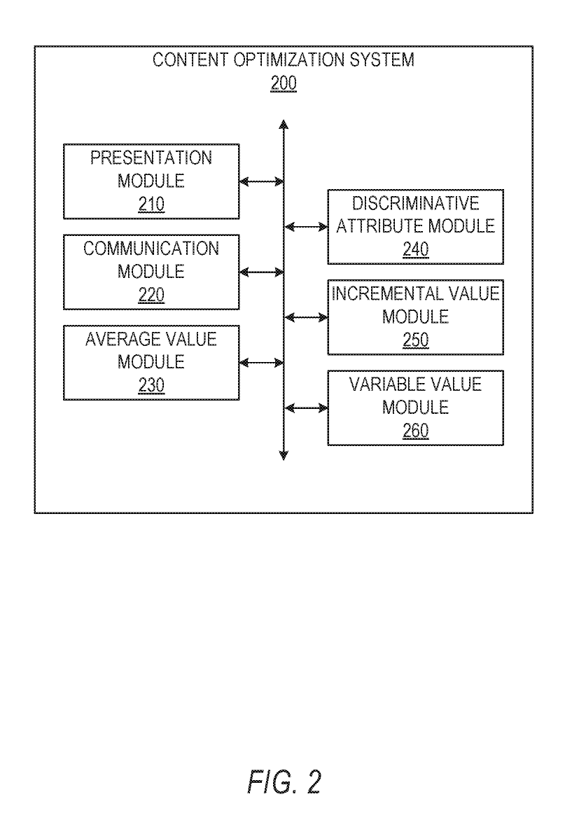

FIG. 2 is a block diagram of the content optimization system 200 that provides functionality to evaluate content items in response to a request to fill a position for a content item in a content list. In an example embodiment, the content optimization system 200 includes a presentation module 210, a communication module 220, an average value module 230, a discriminative attribute module 240, an incremental value module 250, and a variable value module 260. All, or some, of the modules 210-260 of FIG. 2, communicate with each other, for example, via a network coupling, shared memory, and the like. It will be appreciated that each module can be implemented as a single module, combined into other modules, or further subdivided into multiple modules. Other modules not pertinent to example embodiments can also be included, but are not shown.

In some implementations, the presentation module 210 provides various presentation and user interface functionality operable to interactively present (or cause presentation) and receive information from the user. In various example embodiments, the presentation module 210 functions in conjunction with the user interface module 122 of FIG. 1. For instance, the presentation module 210 can cause presentation of a content item in a content list such as a feed, content aggregator, content stream, and the like. In various implementations, the presentation module 210 presents or causes presentation of information (e.g., visually displaying information on a screen, acoustic output, haptic feedback). Interactively presenting information is intended to include the exchange of information between a particular device and the user. The user may provide input to interact with the user interface in many possible manners such as alphanumeric, point based (e.g., cursor), tactile, or other input (e.g., touch screen, tactile sensor, light sensor, infrared sensor, biometric sensor, microphone, gyroscope, accelerometer, or other sensors). It will be appreciated that the presentation module 210 provides many other user interfaces to facilitate functionality described herein. Further, it will be appreciated that “presenting” as used herein is intended to include communicating information or instructions to a particular device that is operable to perform presentation based on the communicated information or instructions.

The communication module 220 provides various communications functionality and web services. For example, the communication module 220 provides network communication such as communicating with the social networking system 120, the client devices 150, and the third party server(s) 146. In various example embodiments, the network communication can operate over wired or wireless modalities. Web services are intended to include retrieving information from the third party server(s) 146, the database(s) 128-132, and the application server module(s) 124. In some implementations, information retrieved by the communication module 220 comprises data associated with the user (e.g., user profile information from an online account, social network service data associated with the user), data associated with one or more items listed on an e-commerce website (e.g., images of the item, reviews of the item, item price), or other data to facilitate the functionality described herein.

The average value module 230 provides functionality to calculate the average monetary value that, in various example embodiments, represents a value for filling an available content position with a job listing. The average value module 230 can access historical data of engagements with job listings previously presented to users of the content feed. For example, the historical data may indicate a total number of engagements resulting from presenting the job listing in the content feed and a total number of engagements resulting when the job listing is omitted from the content feed. The average value module 230 may then determine an increase in engagements resulting from presenting the job listing in the content feed. The average value module 230 may access revenue data associated with presenting job listings in the content feed. For instance, the average value module 230 accesses flat fee payment revenue for presenting the job listings (e.g., a flat fee for presenting the job listing for one month). In various embodiments, the average value module 230 calculates the average monetary value based on the revenue for presenting the job listings and increase in engagements with the job listings. In these embodiments, the average monetary value represents an average value per engagement for presenting job listings in a content feed or another content platform. The average value module 230 can filter the data across job sector, job type, geographic region, or a combination thereof (e.g., calculate an average monetary value for job in a certain job sector such as technology jobs).

The discriminative attribute module 240 provides functionality to identify significant or discriminative attributes or engagement actions. For example, the discriminative attribute module 240 accesses confirmed hire data that indicates when a particular job associated with a job listing has been filled. In some instance, the particular job associated with the job listing has been filled as a result of presenting the job listing. In an example embodiment, the discriminative attribute module 240 determines this by identifying a link between a user engagement with the job listing and an update to the user current employment that indicates the user accepted a job position corresponding to the job listing. The discriminative attribute module 240 correlates the confirmed hires with engagement actions to identify significant or discriminative engagement actions. Put another way, the discriminative attribute module 240 identifies engagement actions that drive confirmed hires.

The incremental value module 250 provides functionality to determine the incremental value representing a diminishing return for subsequent presentations or engagement actions associated with the particular job listing. For instance, if the job listing has been presented one thousand times, there may be a reduced value, as compared to an earlier presentation of the job listing, to presenting the job listing again since there is a chance that the position has been filled and showing the job listing would be moot. That is to say, one a job position is filled, there is little customer value in continuing to promote the job listing.

The variable value module 260 provides functionality to calculate the variable monetary value and the expected value for monetized content items. For example, the variable value module 260 calculates the variable monetary value for positioning a particular job listing within the content list based on the average monetary value and the incremental value. In an example embodiment, the variable value module 260 calculates the first expected value based on the variable monetary value (denoted below as r_{α,variable}) and a likelihood of interaction (e.g., probability the user will interact with or engage with the job listing such as a click). In a specific non-limiting example, the variable value module 260 calculates the first expected value as follows:

Expected Value=Likelihood of Interaction*Variable Monetary Value

For instance, a particular expected value may be a product of an engagement likelihood and monetary value, such as a cost-per-click for an advertisement, or the variable monetary value for an indirectly monetized content item.

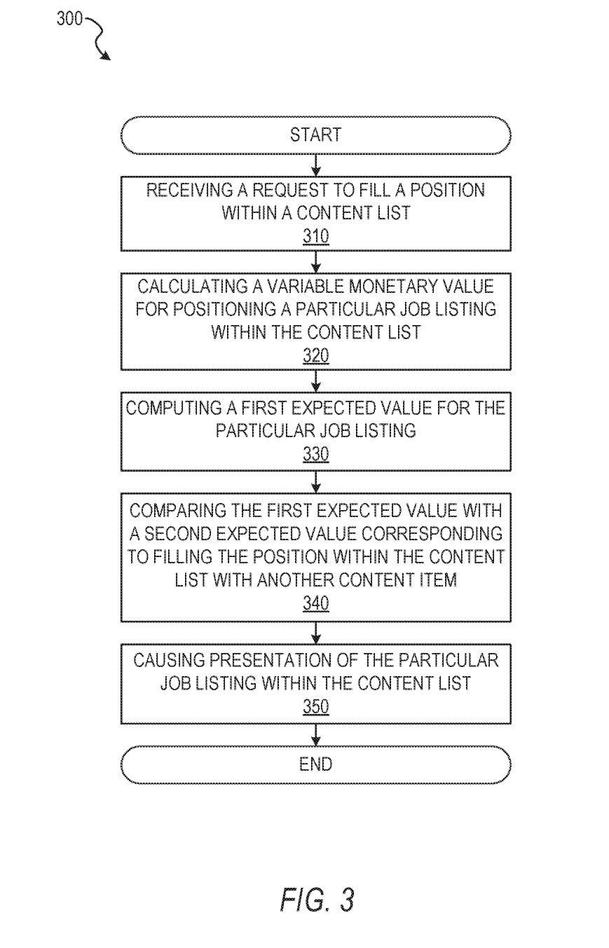

FIG. 3 is a flow diagram illustrating an example method for evaluating content items in response to a request to fill a position in a content list. The operations of the method 300 may be performed by components of the content optimization system 200, and are so described below for the purposes of illustration.

At operation 310, the communication module 220 receives a request to fill a position within a content list being displayed on a user interface of a user device. For example, the user of the user device (e.g., a smart phone or desktop computer) may initiate presentation of a content feed or content list and the user device communicates a request to the social networking system 120 and the content optimization system 200 to populate the content list with content items. Although a content feed or content list is described, the content optimization system 200 may perform the methods and operations described herein in response to content requests from other types of content platforms (e.g., a fixed content space on a user interface that is refreshed periodically with new content).

At operation 320, the variable value module 260 calculates the variable monetary value for positioning the particular job listing within the content list based on the average monetary value and the incremental value for the particular job listing. In these embodiments, the average monetary value, calculated by the average value module 230, represents a value for filling an available content position with a job listing. For example, the average monetary value may be a total revenue collected from presenting job listings divided by an increase in engagement actions resulting from presenting the job listings. In this example, the average monetary value indicates revenue collected per engagement for a job listing.

In various embodiments, the incremental value represents a diminishing return for subsequent presentations or engagement actions associated with the particular job listing. That is to say, a value to a customer of another presentation of the particular job listing (e.g., an employer seeking to fill a vacant position) can diminish the more the particular job listing is presented. For example, the first time the particular job listing is presented may correspond to a highest value to the customer since the job probably has not been filled; an nth time (e.g., one thousandth time) the particular job listing is presented may correspond to a lower value to the customer as compared to the first presentation as the job may have been filled since the first presentation and before the nth presentation.

The variable value module 260 calculates the variable monetary value based on the average monetary value and the incremental value to determine a likely value for a current presentation of the job listing. The value of the current presentation of the job listing may be comparable to a cost-per-click or cost-per-impression of a directly monetized content item such as an advertisement.

At operation 330, the variable value module 260 computes a first expected value for the particular job listing based on the variable monetary value and an interaction likelihood for the particular job listing (e.g., first expected value=variable monetary value*interaction likelihood). The first expected value represents a prediction as to the revenue that may result from presenting the particular job listing. Put another way, for instance, since the variable monetary value represents revenue that may result from an interaction with the job listing and the interaction likelihood represents a probability that a particular user will engage with the job listing, the product of the two values yields a prediction as to revenue that may result from the presentation of the job listing.

At operation 340, the variable value module 260 compares the first expected value with a second expected value corresponding to filling the position within the content list with another content item. The second expected value can be computed similarly, by the variable value module 260, to the computation described at operation 330 above, except the variable value module 260 may use a cost-per-click or cost-per-impression value in place of the variable monetary value for advertisements or another value for content items monetized using other schemes. That is to say, in a scenario where another content item is an advertisement, the variable value module 260 may compute the second expected value based on a cost-per-click, for example, and interaction likelihood for the advertisement. The presentation module 210 or the variable value module 260 may then compare the first expected value directly with the second expected value.

At operation 350, the presentation module 210 causes presentation of the particular job listing within the content list being displayed on the user interface of the user device based on the first expected value exceeding the second expected value. In various embodiments, the presentation module 210 or the variable value module 260 orders, ranks, or sorts content items based on expected values associated with respective content items. For example, the presentation module 210 may display a particular content item corresponding to a highest expect value first, or more prominently (e.g., a more visible or conspicuous placement on the user interface), in the content list. The presentation module 210 can adjust a number of different content item parameters based on the expected value such as a frequency of impressions, a prominence of the display, a location of the display, a size of the display, a duration of the presentation, and so on.

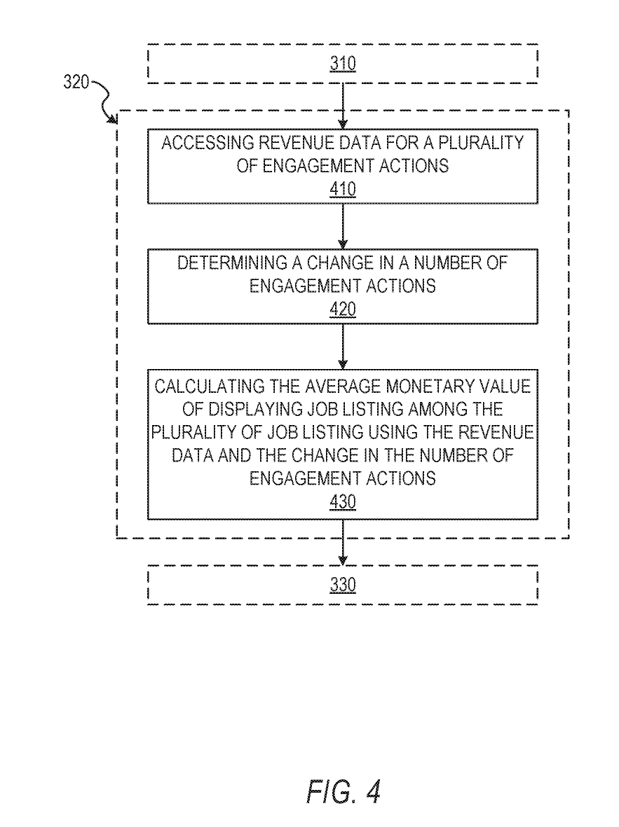

FIG. 4 is a flow diagram illustrating further example operations of the example method 300 for evaluating content items in response to a request to fill a position in a content list. Subsequent to the communication module 220 receiving the request to fill the position within the content list at operation 310, the variable value module 260 calculates a variable monetary value at operation 320. In some embodiments, operation 320 includes the additional operations of FIG. 4.

At operation 410, the average value module 230 accesses revenue data for a plurality of engagement actions associated with a plurality of job listings. For instance, the average value module 230 accesses total revenue received from employers promoting job openings via job listings within the content item feed or content list. In some embodiments, the revenue data is over a specified time period (e.g., revenue from the last month).

At operation 420, the average value module 230 determines a change in a number of engagement actions resulting from displaying the plurality of job listings within the content list compared to omitting the plurality of job listings from the content list. If a time period is specified, the engagement actions should occur within the time period to be counted by the average value module 230. For example, the average value module 230 accesses data that indicates a number of engagement actions (e.g., clicks) for job listings that were not presented in the content item feed or content list. The average value module 230 may then access data that indicates a number of engagement actions for a same or similar job listings that were presented and promoted in the content item feed or content list. The average value module 230 may then use such data to determine how many additional engagement actions resulted from presenting the job listing in the content item feed.

At operation 430, the average value module 230 calculates the average monetary value of displaying job listings among the plurality of job listings using the revenue data and the change in the number of engagement actions. For example, the average value module 230 calculates the average monetary value by dividing the total revenue received from presenting a set of job listings by additional engagement actions resulting from presenting the set of job listings. In this example, the average monetary value represents revenue per engagement action for the set of job listings. In some embodiments, the average value module 230 calculates the average monetary value using revenue and a change in a number of engagement actions from a certain segment of the jobs (e.g., tech sector jobs), for a particular job type (e.g., engineering jobs), for a particular job (e.g., accountant jobs), or all jobs total.

In a specific, non-limiting example, the average value module 230 determines the average monetary value associated with each type of engagement action (denoted by α) such as a job impression, a job view, a saved job, an apply-clicked job, a job application, or a confirmed hire. In this example, the average value module 230 receives the inputs such as a time period, revenue during the time period (denoted by R), number of engagement actions during the time period (denoted by N_{α}), and a number of engagement actions expected through non-revenue driving channels (e.g., organic traffic) during the time period (denoted by N_{αfree}). In this example, the average value module 230 outputs the average monetary value (denoted by r_{α,average}) for each type of engagement action. In an example embodiment, the average value module 230 computes an incremental number of engagement actions or a change in a number of engagement actions resulting from the revenue channel (e.g., number of additional engagement actions resulting from revenue channel versus merely organic engagements from search) as follows:

N_{α,incremental}=N_{α}−N_{α,free}

The average value module 230 may then compute the average monetary value (denoted by r_{α,average}) for an engagement action as follows:

$${r}_{α , average} = \frac{R}{{N}_{α , incremental}}$$

Note that in some instances engagement actions resulting from a particular revenue channel (e.g., recommended job in a feed or content list) are assumed to be equivalent to engagement actions resulting from other revenue channels.

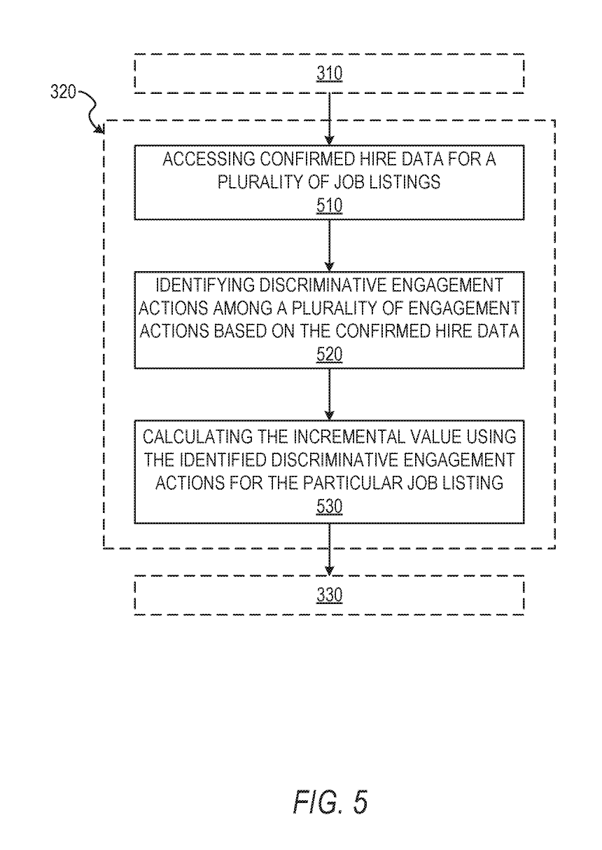

FIG. 5 is a flow diagram illustrating further example operations of the example method for evaluating content items in response to a request to fill a position in the content list or content item feed. Subsequent to the communication module 220 receiving the request to fill the position within the content list at operation 310, the variable value module 260 calculates a variable monetary value at operation 320. In some embodiments, operation 320 includes the additional operations of FIG. 5.

At operation 510, the discriminative attribute module 240 accesses confirmed hire data for a plurality of job listings. The confirmed hire data indicating a job position has been filled. In a specific example, a user that clicked on a particular job listing for a certain job that is later identified as being employed at the certain job may constitute a confirmed hire.

At operation 520, the discriminative attribute module 240 identifies discriminative engagement actions, or significant engagement actions, among a plurality of engagement actions based on the confirmed hire data. In various example embodiments, the discriminative engagement actions are engagement actions likely to result in a confirmed hire for a job listing. For example, the engagement actions may comprise a wide variety of different actions such as a job listing impression, a job listing view, a job listing save action, a job listing click, a job listing application, and so forth. Some of the engagement actions may be far more indicative of a confirmed hire than others. The discriminative attribute module 240 identifies significant or discriminative engagement actions using the confirmed hire data described at operation 510. In a specific example, engagement actions may be normalized based on confirmed hire data and ranked by the discriminative attribute module 240 to identify a highest, or several highest, engagement actions that are correlated with confirmed hires. In a specific example, the discriminative attribute module 240 may access confirmed hire data and engagement action data indicating that on average there are one hundred clicks on a job listing before a confirmed hire occurs and that there are five hundred views of the job listing before the confirmed hire occurs. In this example, the discriminative attribute module 240 may rank the engagement actions such that a click is associated with a value of one over one hundred and a view is associated with a value of one over five hundred and thus the click is more significant than a view in terms of resulting confirmed hires. In some embodiments, the discriminative attribute module 240 determines a weight vector by using a machine learning model (e.g., logistic regression, stochastic gradient descent that output weighted vector w, as a function of feature vector over all jobs) to learn the customer value as a function of the feature vector over all jobs. In still other embodiments, the discriminative attribute module 240 computes top engagement actions based on the pairwise correlation between each engagement action and the customer value (e.g., confirmed hire per engagement action) across all jobs. In various example embodiments, the discriminative attribute module 240 identifies the discriminative engagement actions offline (e.g., at a session and a time prior to the receiving the request to fill the position) and the discriminative attribute module 240 accesses the identified discriminative engagement action data when the request to fill the position is received by the content optimization system 200.

In a specific, non-limiting example, the discriminative attribute module 240, for each type of engagement action (denoted by α), such as a job impression, job view, saved job, apply-clicked job, job application, computes a normalized feature vector (denoted by x_{α,j}) associated with each job (denoted by j) by including attributes such as number of job impressions, number of job view, number of times the job was saved, number of apply clicks for the job, number of applications for the job, and so on at expiration of the job recommendation time period (e.g., one month). Subsequently, the discriminative attribute module 240 calculates the customer value (denoted by y_{αj}) of an engagement action for a job (denoted by j) as follows:

$${y}_{α , j} = \frac{Number of Confirmed Hires Job , j}{Number of Engagement Actions for Job , j}$$

Then, in this example embodiment, the discriminative attribute module 240 determines the relative attribute weight vector (denoted by w_{α}) using a machine learning algorithms applied to learn the customer value as a function of the feature vector over all jobs. The discriminative attribute module 240 then determine the top attributes based on the weight vector (denoted by w_{α}). In some example embodiments, the discriminative attribute module 240 computes the top attributes based on a pair wise correlation between each attribute feature and the customer value across all jobs.

At operation 530, the incremental value module 250 calculates the incremental value using the identified discriminative engagement actions for the particular job listing, the incremental value indicating a value associated with filling the position within the content list with the particular job listing in response to the request. For example, the incremental value module 250 maps engagement actions to an incremental bucket (e.g., segments or separates the engagement actions into groups according to an occurrence count) such as one to ten, ten to one hundred, one hundred to five hundred, and so forth. The incremental value module 250 uses the discriminative attributes, or significant engagement actions, and the weight vector identified at operation 520 to then determine the incremental value using a machine learning model. For example, the incremental value module 250 trains a machine learning model with the discriminative engagement actions data. Once the model is trained, given a job listing and engagement data for the job listing (e.g., number of views, clicks, etc. that have occurred already), the incremental value module 250 can use the model to determine the incremental value of a next engagement action for the job listing.

In a specific, non-limiting example, the incremental value module 250 determines the relative customer value (the incremental value) of a particular job recommendation by mapping engagement actions to buckets (e.g., 1-10, 11-50, 51-100, etc.) of reach type of engagement action (e.g., job impression, job view, saved job, apply-clicked job, job application). The incremental value module 250 then computers a weighted combination of most discriminative attribute features for each job (denoted by j) using weight vector w_{α} (although in a special case, the incremental value module 250 uses one attribute at a time). The incremental value module 250 returns the incremental customer value (denoted by c_{α}(j)) of a particular engagement action for job, j as follows:

$${c}_{α} ( j ) = \frac{d ( {y}_{α , j} )}{d ( {w}_{α} )}$$

In this instance, the incremental value module 250 calculates the derivative with respect to the ‘bucketized’ versions.

Subsequently, the variable value module 260 calculates the variable monetary value using r_{α,average}, the identified discriminative engagement actions, the incremental value (denoted by c_{α}(j)) for engagement actions for job (denoted by j) based on a combination of one or more most discriminative engagement actions. That is to say, in some example embodiments, the variable value module 260 computes the variable monetary value (denoted by r_{α,variable}) for engagement actions of a job j as follows:

r_{α,variable}=c_{α}(j)*r_{α,average}

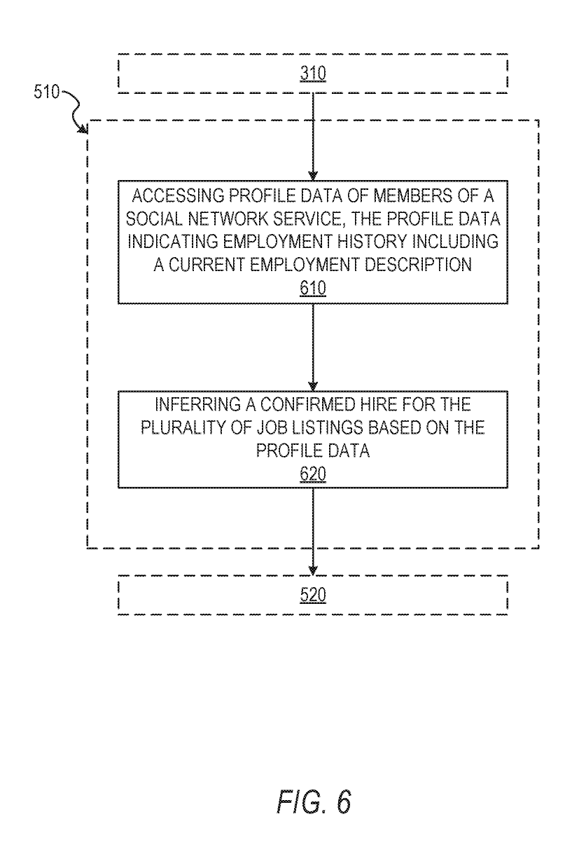

FIG. 6 is a flow diagram illustrating further example operations of the example method 300 for evaluating content items in response to a request to fill a position in a content list. In various example embodiments, at operation 510, the discriminative attribute module 240 accesses confirmed hire data for a plurality of job listings. In some embodiments, the operation 510 includes the additional operations of FIG. 6.

At operation 610, the discriminative attribute module 240 accesses profile data (e.g., profile data stored in databases 128 of FIG. 1) of members of a social networking service, the profile data indicating employment history including a current employment description. For example, the profile data may be data from a professional social networking service and include an employment history for a member associated with the profile data.

At operation 620, the discriminative attribute module 240 infers a confirmed hire for the plurality of job listings by comparing the current employment description with job description data of the plurality of job listings. For example, if the user engages with the job listing (e.g., a click, a job save, or another engagement action) and profile data of the user on the social networking service indicates that the user is currently employed at the job associated with the job listing, the discriminative attribute module 240 may infer a confirmed hire for that job listing. Other schemes may be employed to determine confirmed hires such as user self-reporting or employer reporting.

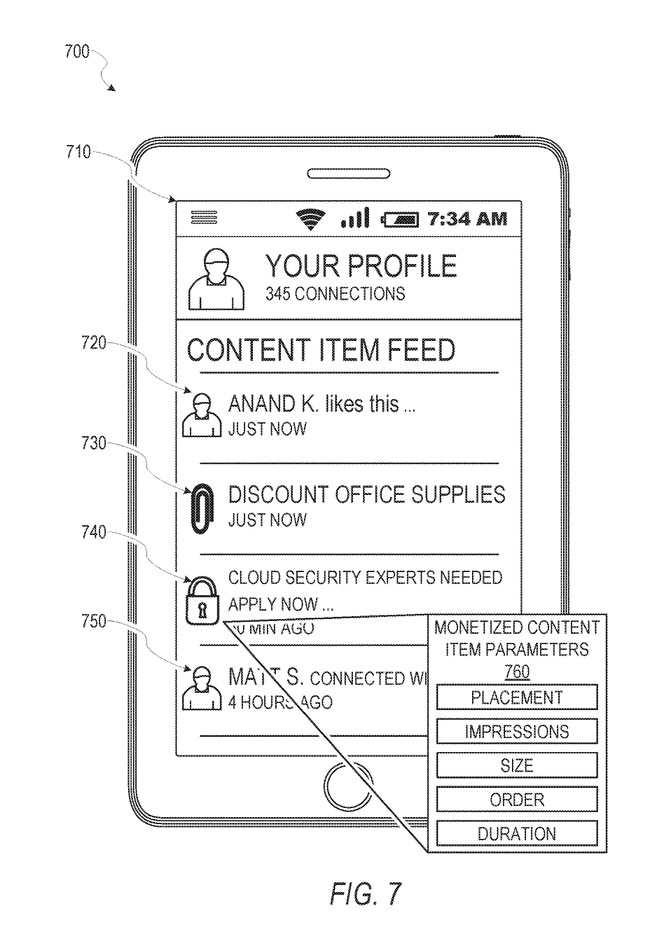

FIG. 7 is a user interface diagram depicting an example user interface that includes a content feed with a mix of content items. Although FIG. 7 depicts specific example user interfaces and user interface elements, these are merely non-limiting examples; many other alternate user interfaces and user interface elements can be generated by the presentation module 210 and caused to be presented to the user (e.g., the user 160). It will be noted that alternate presentations of the displays of FIG. 7 can include additional information, graphics, options, and so forth. Alternatively, other presentations can include less information, or provide abridged information for easy use by the user.

FIG. 7 depicts an example device 700 (e.g., smart phone) displaying an example user interface 710 that includes a content feed, content list, or content aggregator. In this example, the content list of the example user interface 710 includes content items such as content item 720, 730, 740, and 750. These content items are merely examples and many other content items may be presented that include additional information, graphics, media, options, and so on while other presentations include less information. In this example, the content items 720 and 750 are organic content items (e.g., user generated content, news updates, social networking service updates, and so on) in this example. In this example, the content items 730 and 740 are monetized content items. For instance, the content item 730 is an advertisement that is monetized based on the advertisement being interacted with by the user (e.g., a click or tap) or based on a number of impressions delivered to users. In some embodiments, the monetized content item 740 is presented and generated by the presentation module 210 according to monetized content item parameters 760 such as placement, impressions, size, order, duration, and so forth. In various embodiments, the presentation module 210 generates the user interface 710 or aspects of the user interface 710. For example, the presentation module 210 may order content items, omit content items, or otherwise modify content items of the content list based on expected values ascertained by the content optimization system 200. For example, based on the expected value for the content item 740, the content optimization system 200 may alter the placement, number of impressions, size, order, duration of impression, aspects of available user interaction, and other parameters of the content item. In various example embodiments, the content optimization system 200 adjusts, modifies, or alters these parameters to maximize revenue for a particular content list.

Certain embodiments are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some embodiments, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules can be located in a single geographic location (e.g., within a home environment, an office environment, or a server farm). In other example embodiments, the processors or processor-implemented modules are distributed across a number of geographic locations.

The modules, methods, applications and so forth described in conjunction with FIGS. 1-7 are implemented in some embodiments in the context of a machine and an associated software architecture. The sections below describe representative software architecture and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, and the like, while yet another combination produces a server computer for use within a cloud computing architecture. Not all combinations of such software and hardware architectures are presented here as those of skill in the art can readily understand how to implement the inventive subject matter in different contexts from the disclosure contained herein.

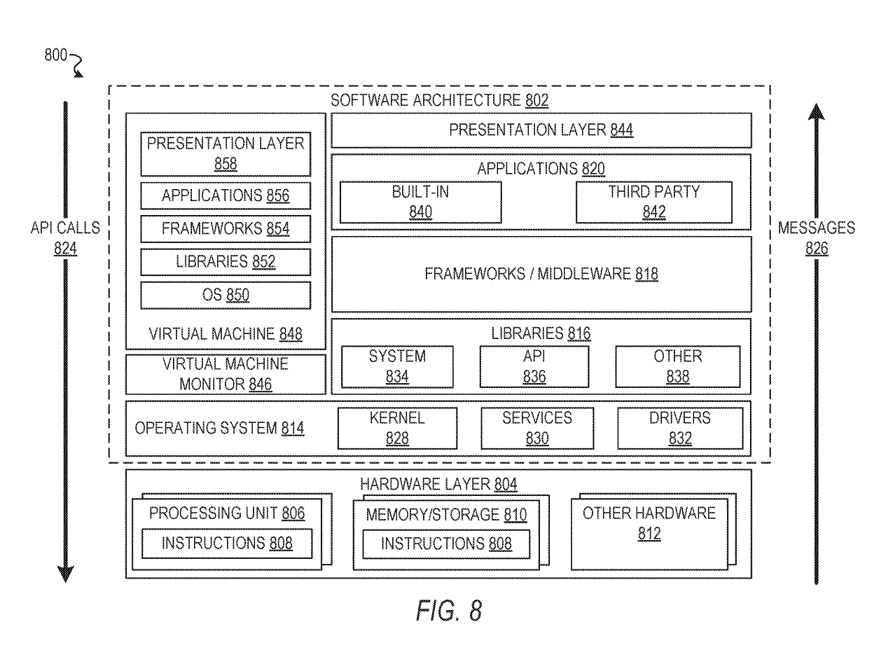

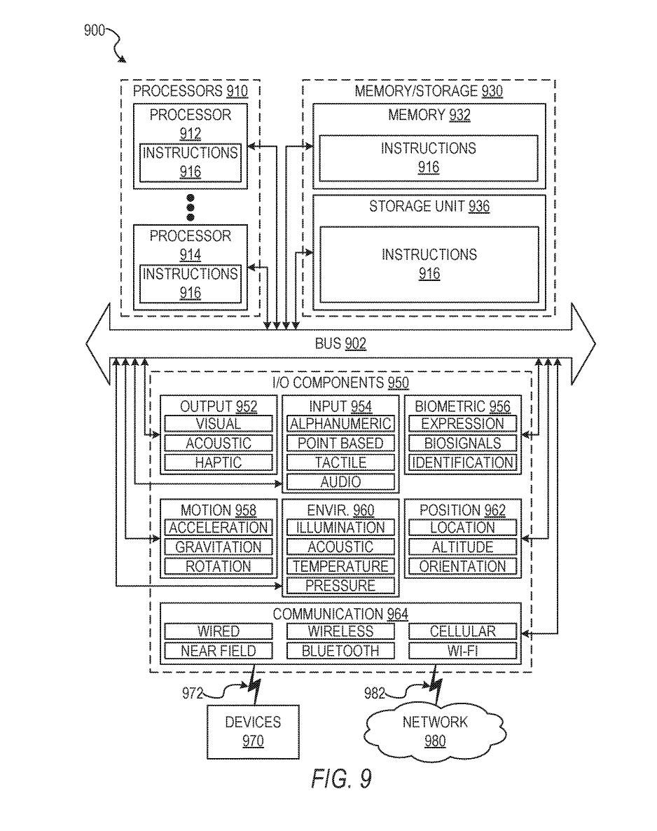

FIG. 8 is a block diagram 800 illustrating a representative software architecture 802, which may be used in conjunction with various hardware architectures herein described. FIG. 8 is merely a non-limiting example of a software architecture and it will be appreciated that many other architectures may be implemented to facilitate the functionality described herein. The software architecture 802 may be executing on hardware such as machine 900 of FIG. 9 that includes, among other things, processors 910, memory/storage 930, and I/O components 950. A representative hardware layer 804 is illustrated and can represent, for example, the machine 900 of FIG. 9. The representative hardware layer 804 comprises one or more processing units 806 having associated executable instructions 808. Executable instructions 808 represent the executable instructions of the software architecture 802, including implementation of the methods, modules and so forth of FIGS. 1-7. Hardware layer 804 also includes memory and storage modules 810, which also have executable instructions 808. Hardware layer 804 may also comprise other hardware 812, which represents any other hardware of the hardware layer 804, such as the other hardware illustrated as part of machine 900.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820 and presentation layer 844. Operationally, the applications 820 or other components within the layers may invoke application programming interface (API) calls 824 through the software stack and receive a response, returned values, and so forth illustrated as messages 826 in response to the API calls 824. The layers illustrated are representative in nature and not all software architectures have all layers. For example, some mobile or special purpose operating systems may not provide the frameworks/middleware 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, BLUETOOTH® drivers, flash memory drivers, serial communication drivers (e.g., Universal Serial Bus (USB) drivers), WI-FI® drivers, audio drivers, power management drivers, and so forth depending on the hardware configuration.

The libraries 816 may provide a common infrastructure that may be utilized by the applications 820 or other components or layers. The libraries 816 typically provide functionality that allows other software modules to perform tasks in an easier fashion than to interface directly with the underlying operating system 814 functionality (e.g., kernel 828, services 830 or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPREG4, H.264, MP3, AAC, AMR, JPG, or PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks/middleware 818 (also sometimes referred to as middleware) may provide a higher-level common infrastructure that may be utilized by the applications 820 or other software components/modules. For example, the frameworks/middleware 818 may provide various graphic user interface (GUI) functions, high-level resource management, high-level location services, and so forth. The frameworks/middleware 818 may provide a broad spectrum of other APIs that may be utilized by the applications 820 or other software components/modules, some of which may be specific to a particular operating system or platform.

The applications 820 include built-in applications 840 or third party applications 842. Examples of representative built-in applications 840 may include, but are not limited to, a contacts application, a browser application, a book reader application, a location application, a media application, a messaging application, or a game application. Third party applications 842 may include any of the built-in applications 840 as well as a broad assortment of other applications. In a specific example, the third party application 842 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or other mobile operating systems. In this example, the third party application 842 may invoke the API calls 824 provided by the mobile operating system such as operating system 814 to facilitate functionality described herein. In an example embodiment, the applications 820) include a social networking service application that provides various social networking service features such as a content feed, aggregator, or list.

The applications 820 may utilize built-in operating system functions (e.g., kernel 828, services 830 or drivers 832), libraries (e.g., system libraries 834, API libraries 836, and other libraries 838), frameworks/middleware 818 to create user interfaces to interact with users of the system. Alternatively, or additionally, in some systems interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware machine (such as the machine 900 of FIG. 9, for example). The virtual machine 848 is hosted by a host operating system (e.g., operating system 814) and typically, although not always, has a virtual machine monitor 846, which manages the operation of the virtual machine 848 as well as the interface with the host operating system (i.e., operating system 814). A software architecture executes within the virtual machine 848 such as an operating system 850, libraries 852, frameworks/middleware 854, applications 856 or presentation layer 858. These layers of software architecture executing within the virtual machine 848 can be the same as corresponding layers previously described or may be different.

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein can be executed. For example, the instructions 916 can cause the machine 900 to execute the flow diagrams of FIGS. 3-6. Additionally, or alternatively, the instruction 916 can implement the presentation module 210, the communication module 220, the average value module 230, the discriminative attribute module 240, the incremental value module 250, the variable value module 260, and so forth. The instructions 916 transform the general, non-programmed machine into a particular machine programmed to carry out the described and illustrated functions in the manner described. In alternative embodiments, the machine 900 operates as a standalone device or can be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 can include processors 910, memory/storage 930, and I/O components 950, which can be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 912 and processor 914 that may execute instructions 916. The term “processor” is intended to include multi-core processor that may comprise two or more independent processors (sometimes referred to as “cores”) that can execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory/storage 930 can include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 can also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of the processors 910 are examples of machine-readable media.

As used herein, the term “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 can include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 can include many other components that are not shown in FIG. 9. The I/O components 950 are grouped according to functionality merely for simplifying the following discussion, and the grouping is in no way limiting. In various example embodiments, the I/O components 950 can include output components 952 and input components 954. The output components 952 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In further example embodiments, the I/O components 950 can include biometric components 956, motion components 958, environmental components 960, or position components 962 among a wide array of other components. For example, the biometric components 956 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 can include acceleration sensor components (e.g., an accelerometer), gravitation sensor components, rotation sensor components (e.g., a gyroscope), and so forth. The environmental components 960 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 962 can include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 950 may include communication components 964 operable to couple the machine 900 to a network 980 or devices 970 via a coupling 982 and a coupling 972, respectively. For example, the communication components 964 include a network interface component or other suitable device to interface with the network 980. In further examples, communication components 964 include wired communication components, wireless communication components, cellular communication components, Near Field Communication (NFC) components, BLUETOOTH® components (e.g., BLUETOOTH® Low Energy), WI-FI® components, and other communication components to provide communication via other modalities. The devices 970 may be another machine or any of a wide variety of peripheral devices (e.g., a peripheral device coupled via a Universal Serial Bus (USB)).

Moreover, the communication components 964 can detect identifiers or include components operable to detect identifiers. For example, the communication components 964 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 964, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 980 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or other type of cellular or wireless coupling. In this example, the coupling 982 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 can be transmitted or received over the network 980 using a transmission medium via a network interface device (e.g., a network interface component included in the communication components 964) and utilizing any one of a number of well-known transfer protocols (e.g., Hypertext Transfer Protocol (HTTP)). Similarly, the instructions 916 can be transmitted or received using a transmission medium via the coupling 972 (e.g., a peer-to-peer coupling) to devices 970. The term “transmission medium” shall be taken to include any intangible medium that is capable of storing, encoding, or carrying the instructions 916 for execution by the machine 900, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving a request to fill a position within a content list being displayed on a user interface of a user device;
calculating, using a hardware processor of a machine, a variable monetary value for positioning a particular job listing within the content list based on an average monetary value and an incremental value for the particular job listing;
computing a first expected value for the particular job listing based on the variable monetary value and an interaction likelihood for the particular job listing;
comparing the first expected value with a second expected value corresponding to filling the position within the content list with another content item; and
based on the first expected value exceeding the second expected value, causing presentation of the particular job listing within the content list being displayed on the user interface of the user device.

2. The method of claim 1, further comprising calculating the average monetary value by:
accessing revenue data for a plurality of engagement actions associated with a plurality of job listings;
determining a change in a number of engagement actions resulting from displaying the plurality of job listings within the content list compared to omitting the plurality of job listings from the content list; and
calculating the average monetary value of displaying job listings among the plurality of job listings using the revenue data and the change in the number of engagement actions.

3. The method of claim 1, further comprising calculating the incremental value by:
accessing confirmed hire data for a plurality of job listings, the confirmed hire data indicating a job position has been filled;
identifying discriminative engagement actions among a plurality of engagement actions based on the confirmed hire data, the discriminative engagement actions being engagement actions likely to result in a confirmed hire for a job listing; and
calculating the incremental value using the identified discriminative engagement actions for the particular job listing, the incremental value indicating a value associated with filling the position within the content list with the particular job listing in response to the request.

4. The method of claim 3, further comprising:
accessing profile data of members of a social networking service, the profile data indicating employment history including a current employment description; and
inferring a confirmed hire for the plurality of job listings by comparing the current employment description with job description data of the plurality of job listings.

5. The method of claim 3, wherein the identifying the discriminative engagement action is performed offline.

6. The method of claim 3, wherein the plurality of engagement actions comprise at least one of a job listing impression, a job listing view, a job listing save action, a job listing click, or a job listing application.

7. The method of claim 1, wherein the another content item comprises a pay-per-click advertisement and the particular job listing is monetized based on a flat fee.

8. A system comprising:
a computer-readable medium having instructions stored thereon, which, when executed by a processor, cause the system to:
receive a request to fill a position within a content list being displayed on a user interface of a user device;
calculate a variable monetary value for positioning a particular job listing within the content list based on an average monetary value and an incremental value for the particular job listing;
compute a first expected value for the particular job listing based on the variable monetary value and an interaction likelihood for the particular job listing;
compare the first expected value with a second expected value corresponding to filling the position within the content list with another content item; and
based on the first expected value exceeding the second expected value, cause presentation of the particular job listing within the content list being displayed on the user interface of the user device.

9. The system of claim 8, wherein the system is further to calculate the average monetary value by:
access revenue data for a plurality of engagement actions associated with a plurality of job listings;
determine a change in a number of engagement actions resulting from displaying the plurality of job listings within the content list compared to omitting the plurality of job listings from the content list; and
calculate the average monetary value of displaying job listings among the plurality of job listings using the revenue data and the change in the number of engagement actions.

10. The system of claim 8, wherein the system is further to calculate the incremental value by:
access confirmed hire data for a plurality of job listings, the confirmed hire data indicating a job position has been filled;
identify discriminative engagement actions among a plurality of engagement actions based on the confirmed hire data, the discriminative engagement actions being engagement actions likely to result in a confirmed hire for a job listing; and
calculate the incremental value using the identified discriminative engagement actions for the particular job listing, the incremental value indicating a value associated with filling the position within the content list with the particular job listing in response to the request.

11. The system of claim 10, wherein the system is further to:
access profile data of members of a social networking service, the profile data indicating employment history including a current employment description; and
infer a confirmed hire for the plurality of job listings by comparing the current employment description with job description data of the plurality of job listings.

12. The system of claim 10, wherein the identifying of the discriminative engagement actions is performed offline.

13. The system of claim 10, wherein the plurality of engagement actions comprise at least one of a job listing impression, a job listing view, a job listing save action, a job listing click, or a job listing application.

14. The system of claim 8, wherein the another content item comprises a pay-per-click advertisement and the particular job listing is monetized based on a flat fee.

15. A machine-readable medium having no transitory signals and storing instructions that, when executed by at least one processor of a machine, cause the machine to perform operations comprising:
receiving a request to fill a position within a content list being displayed on a user interface of a user device;
calculating a variable monetary value for positioning a particular job listing within the content list based on an average monetary value and an incremental value for the particular job listing;
computing a first expected value for the particular job listing based on the variable monetary value and an interaction likelihood for the particular job listing;
comparing the first expected value with a second expected value corresponding to filling the position within the content list with another content item; and
based on the first expected value exceeding the second expected value, causing presentation of the particular job listing within the content list being displayed on the user interface of the user device.

16. The machine-readable medium of claim 15, wherein the operations further comprise calculating the average monetary value by:
accessing revenue data for a plurality of engagement actions associated with a plurality of job listings;
determining a change in a number of engagement actions resulting from displaying the plurality of job listings within the content list compared to omitting the plurality of job listings from the content list; and
calculating the average monetary value of displaying job listings among the plurality of job listings using the revenue data and the change in the number of engagement actions.

17. The machine-readable medium of claim 15, wherein the operations further comprise calculating the incremental value by:
accessing confirmed hire data for a plurality of job listings, the confirmed hire data indicating a job position has been filled;
identifying discriminative engagement actions among a plurality of engagement actions based on the confirmed hire data, the discriminative engagement actions being engagement actions likely to result in a confirmed hire for a job listing; and
calculating the incremental value using the identified discriminative engagement actions for the particular job listing, the incremental value indicating a value associated with filling the position within the content list with the particular job listing in response to the request.

18. The machine-readable medium of claim 17, wherein the operations further comprise:
accessing profile data of members of a social networking service, the profile data indicating employment history including a current employment description; and
inferring a confirmed hire for the plurality of job listings by comparing the current employment description with job description data of the plurality of job listings.

19. The machine-readable medium of claim 17, wherein the identifying the discriminative engagement actions is performed offline.

20. The machine-readable medium of claim 17, wherein the plurality of engagement actions comprise at least one of a job listing impression, a job listing view, a job listing save action, a job listing click, or a job listing application.
